(19) United States
(12) Patent Application Publication
(10) Pub. No.: US 2014/0309801 A1
(43) Pub. Date: Oct. 16, 2014

(54) METHOD FOR PROVIDING CONTROL POWER FOR A POWER NETWORK

(71) Applicants: Georg Markowz, Alzenau (DE); Wolfgang Schweissthal, Mandelbachtal (DE); Carsten Kolligs, Bottrop (DE); Wolfgang Deis, Heidelberg (DE); Anna Flemming, Frankfurt (DE); Michael Igel, Saarbruecken (DE); Stefan Winternheimer, Saarbruecken (DE); Dennis Gamrad, Voerde (DE); Sebastien Cochet, Oberhausen (DE)

(72) Inventors: Georg Markowz, Alzenau (DE); Wolfgang Schweissthal, Mandelbachtal (DE); Carsten Kolligs, Bottrop (DE); Wolfgang Deis, Heidelberg (DE); Anna Flemming, Frankfurt (DE); Michael Igel, Saarbruecken (DE); Stefan Winternheimer, Saarbruecken (DE); Dennis Gamrad, Voerde (DE); Sebastien Cochet, Oberhausen (DE)

(73) Assignees: Evonik Industries AG, Essen (DE); Evonik Degussa GmbH, Essen (DE); STEAG Power Saar GmbH, Saarbruecken (DE)

(21) Appl. No.: 14/357,273

(22) PCT Filed: Oct. 29, 2012
(86) PCT No.: PCT/EP12/71348

§ 371 Date: May 9, 2014

(30) Foreign Application Priority Data
Nov. 10, 2011 (DE) 10 2011 055 252.9

(51) Int. Cl. H02J 3/14

(52) U.S. Cl. CPC H02J 3/14
USPC 700/295

(57) ABSTRACT

Method for the provision of control power for a power supply network, wherein the level of the control power provided is determined depending on a deviation of the actual alternating current frequency from a nominal alternating current frequency of the power supply network, wherein the control power is provided in a pulsed manner in order to increase the efficiency, wherein the control energy provided in a specific time period from the pulsed operation corresponds to the control energy to be provided in the same time period in the case of a continuous operation of a control power source.

The invention relates to a method for providing control power in a power supply network.

Power supply networks are used to distribute power from mainly a plurality of energy producers in large areas among many users and to supply households and industry with energy. Energy producers, mainly in the form of power stations, provide the necessary energy for this purpose. The power production is normally scheduled and provided on the basis of forecast consumption.

However, unscheduled fluctuations can arise in the production and also in the consumption of energy. These may arise on the energy producer side because, for example, a power station or part of the power supply network fails or, for example, in the case of renewable energies such as wind, because the energy production turns out to be higher than forecast. Unexpectedly high or low consumptions can arise in respect of the consumers also. The failure of a part of the power supply network, for example, which cuts some consumers off from the energy supply, can result in a sudden reduction in the power consumption.

Generally, the result of this is that fluctuations in the network frequency occur in power supply networks due to unscheduled and/or short-term deviations in power production and/or consumption. The required alternating current frequency is, for example, 50 Hz in Europe. A reduction in the consumption compared with the schedule results in an increase in the frequency in the case of scheduled fed-in power by the energy producers, and the same applies to an increase in the power production compared with the schedule in the case of scheduled consumption. Conversely, a reduction in the power of the energy producers compared with the schedule results in a reduction in the network frequency in the case of scheduled consumption, and the same applies to an increase in the consumption compared with the schedule in the case of scheduled production.

For reasons of network stability, it is necessary for these deviations to be kept within a defined framework. To do this, targeted, positive control power must be provided, depending on the level and direction of the deviation, through connection of additional producers or disconnection of consumers or negative control power through disconnection of producers or connection of consumers. The need generally exists for an economical and efficient provision of these control powers, wherein the requirements for the capacities to be retained and the dynamics of the control power sources and sinks may vary according to the characteristic of the power supply network.

In Europe, there is, for example, a code (UCTE Handbook) which describes three different control power categories. The respective requirements for the control power types are also set out therein. The control power types differ, inter alia, in the requirements for the dynamics and the duration of the power provision. Furthermore, they are used differently in terms of the boundary conditions. Primary control power is to be provided independently from the location of the cause of the disruption on a pan-European basis from all incorporated sources, essentially in proportion to the prevailing frequency deviation. The absolute maximum power is to be provided in the case of frequency deviations of minus 200 mHz and (absolutely) thereunder, while the absolute minimum energy is to be provided in the case of frequency deviations of plus 200 mHz and above. In terms of dynamics, the respective maximum energy (in terms of amount) must be provided from the idle state within 30 seconds. Conversely, secondary control power and minute reserve power are to be provided in the balance areas in which the disruption has occurred. Their role is to compensate for the disruption as quickly as possible and thus ensure that the frequency again lies in the target range as quickly as possible, preferably after 15 minutes at the latest. In terms of dynamics, less stringent requirements are imposed on the secondary control power and the minute reserve power (5 and 15 minutes respectively until full power provision following activation), and at the same time these powers are also to be provided over longer time periods than primary control power.

In currently operated power supply networks, a large part of the control power is provided by conventional power stations, in particular coal-fired and nuclear power stations. Two fundamental issues arise from this. On the one hand, the conventional power stations providing control power are not operated at full load and therefore at maximum efficiencies, but slightly below the same in order to be able to provide positive control power on demand, if necessary over a theoretically unlimited time period. On the other hand, with increasing expansion and increasing preferred use of renewable energies, fewer and fewer conventional power stations are in operation, which, however, is often the basic prerequisite for the provision of control powers.

For this reason, approaches have been developed for the increasing use of stores to store negative control power or energy and make it available as positive control power or energy. If the control power from conventional power stations is substituted through provision from stores, the conventional power stations in operation can be operated with a higher efficiency.

The use of hydropump storage units for the provision of control power represents the prior art. In Europe, all of the three abovementioned control power types are provided by pump stores. However, hydropump stores are also repeatedly cited as currently the most economical technology for the input and output of preferably renewable energies into/from storage in order to be able to match energy supply and demand more effectively with one another over time. The potential for the expansion of storage capacities—particularly in Norway—is a controversial issue, since considerable capacities have to be installed and approved in power lines for the use. Consequently, the use for energy production load management is in competition with the provision of control power.

Against this background, approaches for using different storage technologies such as, for example, flywheel mass and battery stores, for the provision of control power have repeatedly been investigated and described in the recent past in the area of primary control power.

From US 2006/122738 A1, an energy management system is known which comprises an energy producer and an energy store, wherein the energy store is chargeable by the energy producer. An energy producer which does not guarantee consistent energy production in normal operation, such as, for example, the increasingly preferred renewable energies, such as wind power or photovoltaic power stations, is thereby intended to be enabled to feed its energy more consistently into the power supply network. The disadvantage here is that, although an individual power station can thus be stabilized, all other disruptions and fluctuations in the power supply network cannot be compensated, or can be compensated to a very limited extent only.

DE 10 2008 046 747 A1 proposes, for example, to operate an energy store in an isolated power supply network in such a way that the energy store is used to equalize consumption peaks and consumption minima.

It is known from WO 2010 042 190 A2 and JP 2008 178 215 A for energy stores to be used for the provision of positive and negative control power. If the system frequency leaves a tolerance range around the required system frequency, energy is either provided from the energy store or fed into the energy store in order to regulate the system frequency. DE 10 2008 046 747 A1 also proposes to operate an energy store in an isolated power supply network in such a way that the energy store is used to equalize consumption peaks and consumption minima. The disadvantage here is that the energy stores do not have the necessary capacity to equalize a lengthy disruption or a plurality of disruptions in succession, rectified in terms of the frequency deviation.

In the article entitled “Optimizing a Battery Energy Storage System for Primary Frequency Control” by Oudalov et al., in IEEE Transactions on Power Systems, Vol. 22, No. 3, August 2007, the capacity of a battery is determined by technical and operational boundary conditions, so that said battery can provide primary power control in accordance with the European standards (UCTE Handbook). It is evident that, in the long term at different time intervals, a charging or discharging of the store at lengthy time intervals is repeatedly unavoidable due to the storage input and output losses. For this purpose the authors propose the time periods in which the frequency is in the deadband, i.e. in the frequency range in which no control power is to be provided. Nevertheless, this may result in the store being overcharged in the short term or temporarily. Here, the authors propose the (limited) use of resistors which, at the extremes, absorb the complete negative rated control power, i.e. must be designed for this purpose. However, as already mentioned by the authors themselves, along with the additional investment requirement for the resistors and their cooling, this results in a more or less unwanted energy degradation, wherein the resulting waste heat cannot normally be used. The authors point out that a lesser use of the loss production is possible only through a higher storage capacity, associated with higher investment costs.

The disadvantage in the provision of control power is that the required components of such devices, such as, for example, a battery or an accumulator, wherein both terms are to be understood below as being synonymous, and also an inverter or other components must always be designed for a full-load operation. In practice, however, a corresponding device is often run in full-load operation only in a maximum of 50% of the active time of the control power provision, in some cases significantly less frequently than 50% of the time. A partial-load operation is required in the remaining active time.

However, the efficiency of some of the components used is in part strongly dependent on the load. It is known, for example, that the efficiency of specific components in the case of a small load is low and rises only in the event of a higher load. This is therefore problematic, since, in the case of positive or negative control power, additional energy must be fed in or consumed during at least 50% of the time due to the suboptimal efficiency in partial-load operation. For example, in the case of negative control power, significantly less energy will arrive in the store than is consumed by the network during at least 50% of the time due to the suboptimal efficiency in partial-load operation. On the whole, this results in an increased tendency to discharge over the duration of the operation and requires suitable countermeasures to a greater extent.

If, for example, an inverter is required for the provision of the control power in order to provide the control power with the required alternating current frequency or to consume said power, as is the case, for example, with battery stores for the provision of control power, additional losses occur due to the efficiency of the inverter. The efficiency of an inverter is significantly greater in the case of high loads than in the case of a very low load, so that the provision of control power on a small scale, i.e. in the partial-load range, incurs increased losses.

The object of the invention is to overcome the disadvantages of the prior art. In particular, a method for the provision of control power is intended to be provided which enables a high efficiency in the control power provision.

Furthermore, the energy producers and energy consumers are intended to have an energy yield which is as efficient as possible as control power suppliers.

The method according to the invention is furthermore intended to be suitable for being able to provide the necessary control power on demand as quickly as possible.

In particular, it is intended that the method can be carried out as simply and economically as possible.

In addition, it is intended that the method can be carried out with as few method steps as possible, wherein said steps are intended to be simple and reproducible.

Further objects not explicitly named can be inferred from the overall context of the following description and the claims.

This object is achieved by a method for the provision of control power for a power supply network, wherein the level of the control power provided is determined depending on a deviation of the actual alternating current frequency from a nominal alternating current frequency of the power supply network, wherein the control power is provided in a pulsed manner in order to increase the efficiency, wherein the control energy provided in a specific time period from the pulsed operation corresponds to the control energy to be provided in the same time period in the case of a continuous operation of a control power source.

A specific time period is understood, according to the invention, to mean a time interval in which control power must be provided. The provision of control power may, for example, be indicated by a requirement of the network operator or on the basis of a measured frequency deviation in the network frequency from the nominal frequency (in Europe, for example, 50.000 Hz). The time period is normally derived accordingly from the type of control power and the corresponding regulations. The length of the time period is uncritical here, wherein, however, said time period must be selected in such a way that the control power is provided in accordance with the regulations. Due to the unsteady power provision in the case of the pulsed operation, short-term, small deviations between the control energy provided from the pulsed and the continuous operation inevitably occur repeatedly within a time period considered. In this connection, a correspondence of the control energies provided by pulsed and continuous operation is understood also to mean the cases in which the difference between the control energies provided by a pulsed operation and by a continuous operation at no time corresponds to more than five times, preferably twice, specifically once the simple summed energy content of the first and last pulse in the time period considered.

All terms such as level, reduction, rise, fall, rising, falling, etc., are always to be understood as referring to amounts.

It is also preferred that a duty cycle according to DIN IEC 60469-1 lies in the range from greater than zero to 1, in particular 0.05 to 0.9, preferably in a range from 0.1 to 0.5, and/or at least temporarily no control power and, alternately or deferred, pulses are provided with a control power level in a range from 2% to 35% of the rated power of a control power source, preferably in a range from 5% to 25% of the rated power.

Furthermore, in a specifically preferred embodiment, the time intervals from the beginning of a pulse until the beginning of the following pulse are restricted to a maximum interval of 5 min, preferably a maximum interval of 2 min, specifically preferably to a maximum interval of 30 s, and quite particularly preferably to a maximum interval of 15 s.

According to the invention, it may also be preferred that, for a reduction in harmonics or the like, the control power is provided with a rising or falling edge preceding or following a pulse, in particular an edge with a duration of 1 to 3 seconds, preferably of 2 s, particularly preferably 1 s, and/or the control power is provided with a pulse with a graduated, in particular multiply graduated, pulse height, so that only a proportion of the control power to be provided is provided throughout the duration of a pulse at the beginning and/or at the end of the pulse, and/or a power gradient within a range from 1 to 1000 kW per second, preferably 2 to 500 kW per second, quite particularly preferably 5 to 50 kW per second in terms of amount is not exceeded.

It can also be provided that the frequency and the number of the pulses, the duty cycle of the pulses, the height of the pulses and/or the shape of the pulses is set for the provision of the required control power depending on the inertia of the power supply network and/or local transmission characteristics of a power supply network, in particular an impedance, capacitance, and/or the like of the power supply network.

It can be provided here that the control power is provided depending on the efficiency of an energy producer, an energy store, an energy consumer, an inverter, the inertia of the power supply network, local transmission characteristics of a power supply network and/or further components of a device for the provision of control power.

It is also preferred that, for a determination of the required control power, the actual alternating current frequency of the power supply network is measured and, in the event of a deviation from a nominal alternating current frequency or a deviation from a tolerance range around a nominal alternating current frequency, control power is fed into the power supply network or is drawn from the power supply network and/or, in the event of a return of the actual alternating current frequency to the nominal alternating current frequency or into the tolerance range, the control power is reduced, in particular to zero.

A control power provided via pulses (impulses) enables an improvement in the efficiency of the device and the method for providing control power, since the necessary power electronics, particularly with the use of batteries, can thus be operated with a higher efficiency. A pulse is understood to mean a temporally limited, impulsive current, voltage or power characteristic, wherein these pulses can also be used as a repeating sequence of pulses. The duty cycle according to DIN IEC 60469-1 can be selected here depending on the type of power electronics and the control power to be provided, wherein said cycle lies in the range from greater than zero to 1, in particular in the range from 0.05 to 0.9, preferably in a range from 0.1 to 0.5.

It can be provided that the control power is provided with an energy store, an energy producer and/or an energy consumer.

According to a preferred design of the present invention, the method can be carried out with an additional control power provider. In this context, control power providers are devices which can provide control power, but do not represent an energy store. Control power providers include, in particular, energy producers and energy consumers.

It can be provided according to the invention that a power station, preferably a coal-fired power station, a gas-fired power station and/or a hydroelectric power station is used as an energy producer, and/or a plant for the production of a substance, in particular an electrolysis plant or a metal plant, preferably an aluminium plant or a steel plant, is used as an energy consumer.

Energy producers and energy consumers of this type are well-suited to the provision of longer-term control powers, but are inert. They can be effectively dynamized with suitable energy stores.

It can preferably be provided that a flywheel, a heat store, a hydrogen producer and store with a fuel cell, a natural gas producer with a gas-fired power station, a pumped storage power station, a compressed air storage power station, a superconducting magnetic energy store, a redox flow element and/or a galvanic element is used as an energy store, preferably a battery or combinations (“pools”) of stores or of stores with conventional control power sources or of stores with consumers and/or energy producers.

A heat store operated as an energy store must be operated together with a device for the production of power from the stored heat energy.

The batteries include, in particular, lead batteries, sodium nickel chloride batteries, sodium sulphur batteries, nickel iron batteries, nickel cadmium batteries, nickel metal hydride batteries, nickel hydrogen batteries, nickel zinc batteries, tin sulphur lithium ion batteries, sodium ion batteries and potassium ion batteries.

Batteries which have a high efficiency and a long operational and calendar life are preferred here. Accordingly, preferred batteries include, in particular, lithium ion batteries (e.g. lithium polymer batteries, lithium titanate batteries, lithium manganese batteries, lithium iron phosphate batteries, lithium iron manganese phosphate batteries, lithium iron yttrium phosphate batteries) and further developments of these batteries, such as, for example lithium air batteries, lithium sulphur batteries and tin sulphur lithium ion batteries.

Lithium ion batteries in particular are particularly suitable for methods according to the invention due to their fast response time, i.e. in terms of both the response time and the rate at which the power can be increased or reduced. Furthermore, efficiency is high, particularly in the case of Li-ion batteries. Furthermore, preferred batteries show a high output-to-capacity ratio, wherein this parameter is known as the C-rate.

It can also be provided that an energy of at least 4 kWh can be stored in the energy store, preferably of at least 10 kWh, particularly preferably at least 50 kWh, quite particularly preferably at least 250 kWh.

According to a further design, the energy store can have a capacity of 1 Ah, preferably 10 Ah and particularly preferably 100 Ah.

If stores are used which are based on electrochemical elements, in particular batteries, this store can advantageously be operated with a voltage of at least 1 V, preferably at least 10 V and particularly preferably at least 100 V.

The target state of charge of the energy store can preferably lie in the range from 20 to 80% of the capacity, particularly preferably in the range from 40 to 60%. The adherence to and/or return into these state of charge ranges can, for example, be achieved using the operating mode on which this invention is based and/or by way of the energy trading via the power supply network previously explained in detail. The state of charge corresponds, particularly in the case of batteries as energy stores, to the state of charge (SoC) or the state of energy (SoE).

The target state of charge of the energy store can depend on forecast data. Consumption data in particular, which are dependent on the time of day, the day of the week and/or the time of year, can thus be used to determine the optimum state of charge.

Through a combination of control power providers with an energy store, a lasting provision of control power can, in particular, be achieved without the existence of a limitation in terms of a state of charge or a capacity of the energy store, or the capacity can be selected as significantly smaller. Thus, in the event of a minor deviation in the mean value, formed over a lengthy period, of the network frequency from the specified frequency, the control power provider can feed in, remove or equalize the energy in the energy store which the energy store has increasingly fed into or removed from the network due to this trend in order to effect a control in line with the specified frequency. This generally requires relatively small amounts of energy. In the case of a persistent deviation in the network frequency, particularly over lengthy periods amounting to at least 10 minutes, preferably at least 15 minutes and specifically preferably at least 30 minutes, the control power supplier can at least partially replace the energy store.

It can be provided here that the energy producer and/or the energy consumer has or have a rated power of at least 5 kW, preferably at least 20 kW, particularly preferably at least 100 kW and, in particular, particularly preferably 1 MW.

It is preferable here that at least two, preferably three or more, energy stores, energy producers and/or energy consumers are jointly operated for a provision of control power (pool), wherein the control power is provided at least up to a proportion, to be defined, of the rated power of the total pool, alternately by at least one energy store, at least one energy store and at least one energy producer and/or at least one energy store, in particular the energy store in the form of a battery and/or a battery store power station, particularly preferably in the form of a lithium ion battery, and at least one energy consumer, while the further energy stores, energy producers and/or energy consumers preferably provide no control power.

It can also be provided here that the control power is provided in a pulsed manner in a first power provision range from 0% of the rated power up to 80% of the rated power of a control power source, in particular in a range from 0% of the rated power up to 50% of the rated power of a control power source, preferably a range from 0% of the rated power up to 35% of the rated power of a control power source, particularly preferably a range from 0% of the rated power up to 20% of the rated power of a control power source, and the control power is provided continuously in a second power provision range, with a higher control power which is to be provided.

It can be provided here that at least two, preferably three or more, energy stores, energy producers and/or energy consumers are jointly operated for a provision of control power, wherein the control power is provided alternately by at least one energy store, at least one energy store and at least one energy producer or at least one energy store and at least one energy consumer, while the further energy stores, energy producers and/or energy consumers preferably provide no control power.

The invention also provides a device to carry out a method according to the invention, wherein it can be provided in particular that the device comprises a control or regulation and an inverter, wherein, in particular, the energy producer, the energy store and/or the energy consumer can be operatively connected to the power supply network by means of the inverter and the control controls the provision of the control power, wherein a pulsed feed or removal of energy into or from the energy store, the energy producer and/or the energy consumer can be controlled or regulated.

Finally it is preferable that the device comprises a measuring means for measuring the actual alternating current frequency of the power supply network and a store, and the control or regulation compares a nominal network frequency stored in the memory, in particular in a memory of a computer, for determining the control power which is to be provided, with the measured actual alternating current frequency and regulates the provision of the control power on the basis of this comparison.

The invention is therefore based on the surprising realization that the efficiency of a device for providing control power can be substantially increased by a method in which the required control power is not provided continuously, but in a pulsed manner, so that the arithmetic mean value of the pulses corresponds to the required control energy.

A further reason for this is that power electronics can be operated at higher powers with a higher efficiency. This is exploited by the present invention. Furthermore, the present invention exploits the fact that, in power supply networks with many consumers and many producers, the pulsed operating mode is “smoothed”, i.e. the sharp pulses which are supplied by the method are equalized to a mean value due to the inertia of the power supply network.

A control power is required whenever the actual alternating current frequency in a power supply network deviates from the nominal alternating current frequency. It can also be provided here that no control power needs to be provided within a frequency band, in Germany, for example, in a frequency band of ±10 mHz around the nominal alternating current frequency of 50 Hz. A limit at which the maximum possible control power has to be provided is defined in Europe at ±200 mHz.

In the range between these values, only a specific proportion of the maximum or rated control power, i.e. the rated power of a control power source, is intended to be fed into the power supply network in Europe. In order to prevent the occurrence in this intermediate range of a lower efficiency of the components of a device for providing control power, it has proven advantageous if the control power is provided in a pulsed manner. Due to the inertia of the power supply network, the actually provided control energy corresponds to the arithmetic mean value of the control power pulses provided.

By means of such a method according to the invention, it can be achieved that a provision of control power can take place with a higher efficiency of the required components for the provision than in the case of an entirely continuous power provision.

Control power is normally made available by the provider to the network operator for a specific rated power. Rated power is understood here to mean the power with which the control power source which is operated with a method according to the invention is at least prequalified. However, the prequalification power may be higher than the maximum rated power which is made available to the network operator. This rated power can also be referred to as the maximum contracted power, since this is the maximum power made available to the network.

According to the invention, this rated power may advantageously lie at least in the range of the maximum power of the energy producer or the energy consumer.

This is important particularly because, as already explained, the components of a control power source must always be designed for an operation with maximum power or rated power.

It has proven to be particularly advantageous if, at least temporarily, no control power is provided and, alternately or deferred, pulses with a control power level in a range from 2% to 35% of the rated power of a control power source, preferably with 20% of the rated power are provided, preferably in a range from 5% to 25% of the rated power or with pulses with a control power level with optimum efficiency of the energy producers, energy consumers and/or further components of a control power source.

The resulting effective control power and therefore the control energy provided can be set, for example, via the duty cycle, the frequency and/or the height of the pulses. It is thus possible that any intermediate control power values between zero and the rated power can always be provided with the optimum achievable efficiency of the device operated with the method according to the invention.

For the power supply network, such a pulsed provision of control power is, under certain circumstances, associated with only minor negative influences, since the power supply network is inert due to a multiplicity of rotating masses, for example in power stations in the energy production or in consumers. The inertia may be so great here that a pulsed control power according to the invention, with comparably low required control power for the stabilization of the actual alternating current frequency compared with the total power of the power supply network, is to some extent smoothed. For example, it can be provided that, instead of the continuous provision of 50 kW control power over 5 s, no control power is provided over a time period of 4 s and a pulse with a power of 250 kW is provided over 1 s, so that the control energy provided is identical in the two comparable time periods.

The difference is then that, in the case of the pulsed control power provision, the efficiency is considerably higher and therefore fewer losses occur. This reduces the costs for the provision of control power without major conversion work being required on the already existing devices for the provision of the control power.

It can also be provided that the pulses can be started via an edge for a reduction in harmonics in the power supply network, which may theoretically occur due to such a pulsed provision of control power. It has proven to be advantageous here if the transition from no control power to the maximum or optimum control power pulse and vice versa takes place within a specific minimum time. This means that a rising or falling edge which counteracts an overshoot is provided preceding or following a provision of the control power. It may be advantageous here, for example, that the power gradient within a range from 1 to 1000 kW per second, preferably 2 to 500 kW per second, quite particularly preferably 5 to 50 kW per second in terms of amount is not exceeded.

The resulting additional losses due to the non-optimal efficiency of the components of the device can be justified under certain circumstances in terms of network stability, since it is ensured by these slower edges or slopes of the rise or fall of the control power by means of said edges that no impermissible or unwanted stimulations of disruptions and oscillations occur in the power supply network or in the connected consumers and producers due to a power gradient which is too steep.

The frequency, number, duty cycle, height and shape, edges and/or graduation of the pulses may be determined here according to the required control power and also the impact of the pulses on the power supply network, and also the total number of power supply sources operated via pulses, wherein the impacts of the pulses on the power supply network depend, inter alia, on its inertia and the electrical engineering network characteristic, in particular depending on a connection to the low-voltage or high-voltage network, and also on an influence of impedance, capacitance and resistance values of the respective network in the vicinity of the connection. The precise design of the pulse height, i.e. the power of a pulse, particularly in relation to the possible maximum power or rated power, can also be defined here depending on the efficiency of the employed energy store, energy producer, energy consumer, of an inverter or of the further components. In a further preferred embodiment, the frequency, number, duty cycle, height and shape, edges and/or graduation of the pulses are determined by specifications which the transmission network operator, for example, makes dependent on the time of day, the day of the week and/or the time of year. For example, the design possibilities may be more narrowly defined or excluded in a time period from 5 min before to 5 min after the hour change. This is justified in that very rapid frequency changes often occur here. It may be in the interest of the transmission network operators that less severe disruptions are caused and therefore the control energy is provided more reliably in the sense of a sharper focus.

It may be provided that the actual alternating current frequency of the power supply network is measured in order to determine the required control power. The measured actual alternating current frequency is compared with the nominal alternating current frequency and the effective control power to be provided can be determined from this comparison.

It may prove advantageous here if a power station, preferably a coal-fired power station, a gas-fired power station or a hydroelectric power station, is used as an energy producer, and/or a plant for the production of a substance, in particular an electrolysis plant or a metal plant, preferably an aluminium plant or a steel plant, is used as an energy consumer.

Positive control power, i.e. control power to increase the actual alternating current frequency of the power supply network, can be provided by means of the energy producers, and negative control power, i.e. control power to reduce the actual alternating current frequency of the power supply network, can be provided by means of the energy consumers. However, it can also be provided that positive control power can also be provided by energy consumers by reducing the consumption, and/or negative control power can also be provided by producers by reducing the production. If an actual alternating current frequency is measured which is too high, this can be reduced through targeted, pulsed connection of an energy consumer. If an actual alternating current frequency is measured which is too low, the actual alternating current frequency is increased by providing positive, pulsed control power by means of an energy producer.

In particular, it may be advantageous to use an energy store as a control power source. The energy store may be provided, for example, in the form of a flywheel, a hydrogen producer and store with a fuel cell, a hydrogen gas turbine, a hydrogen-powered engine, a natural gas producer with a gas-fired power station, a pumped storage power station, a compressed air storage power station, a superconducting magnetic energy store, a redox flow element and/or a galvanic element, preferably a battery and/or a battery storage power station, particularly preferably a lithium ion battery. The energy store may also be jointly operated here with an energy producer and/or an energy consumer.

Lithium ion batteries in particular are particularly suitable for methods according to the invention due to their fast response time, i.e. in terms of both the response time and the rate at which the power can be increased or reduced. Furthermore, efficiency is high, particularly in the case of Li-ion batteries. Furthermore, preferred batteries show a high output-to-capacity ratio, wherein this parameter is known as the C-rate.

An energy store, an energy producer and/or an energy consumer with a maximum power or rated power of at least 1 kW, 5 kW, 10 kW, 20 kW, 100 kW, 500 kW, or 1 MW can preferably be used here.

A device to carry out a method according to the invention may comprise an energy store, an energy producer, an energy consumer, a control and preferably an inverter, wherein, in particular, the energy store is connected by means of the inverter to a power supply network and the control controls the provision of the control power.

The device may comprise a measuring means for measuring the actual alternating current frequency of the power supply network and a store to control the provision of the control power. Furthermore, it can be provided that a computer with a memory is included. In particular, the nominal alternating current frequency and also the power to be provided in the event of a deviation from said frequency are stored in the memory. The measuring means can continuously measure the actual alternating current frequency here, wherein this value is preferably compared continuously with the nominal alternating current frequency so that the control power and the type of provision (pulsed or continuous) of the device are regulated on the basis of this comparison and the stored power requirement. dr

Example embodiments of the invention are explained below with reference to schematically presented figures, but without restricting the invention. Here:

FIG. 1: is a schematic P-f diagram of the quasi-steady-state requirement for a control power provision depending on a deviation f of the actual alternating current frequency from the nominal alternating current frequency;

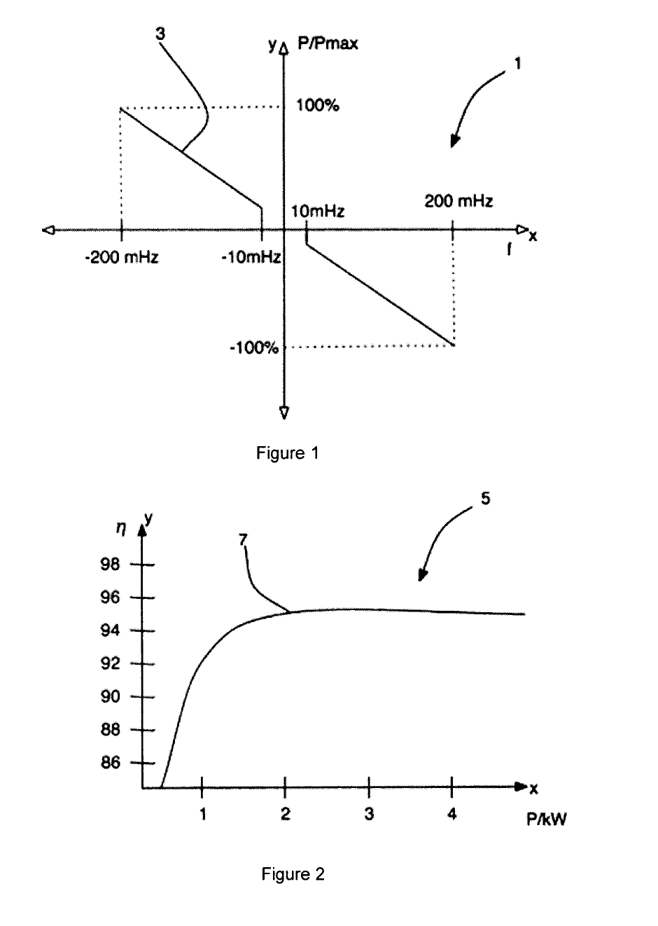

FIG. 2: is a schematic diagram of the efficiency of an inverter depending on the power;

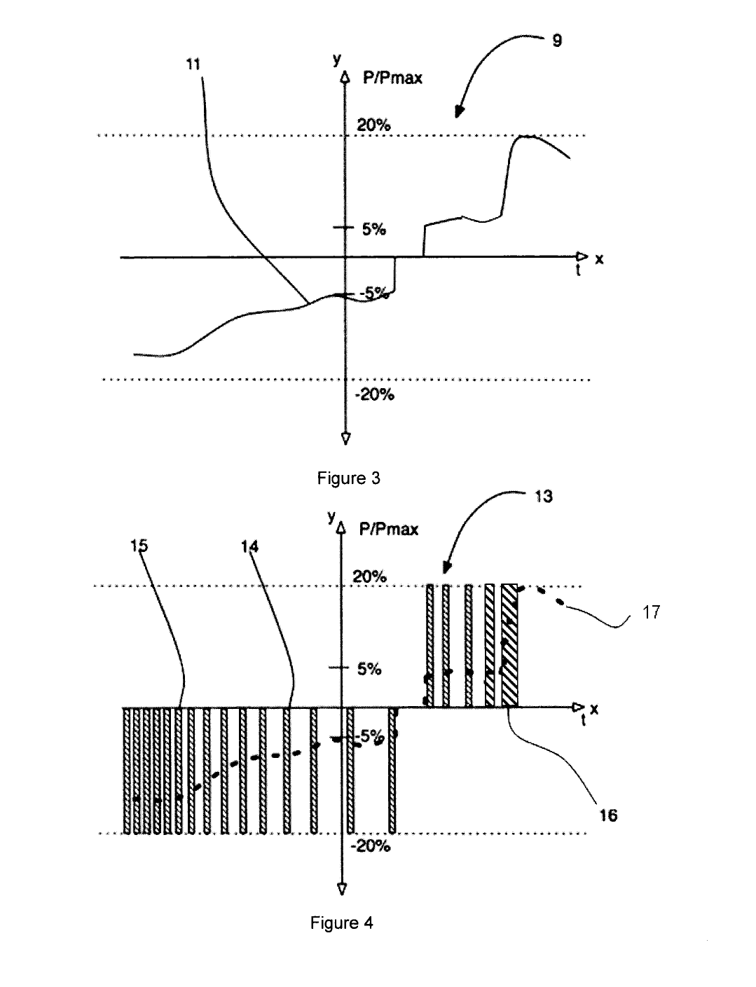

FIG. 3: is a schematic P-t diagram with an example of a characteristic of a provision of control power according to the prior art;

FIG. 4: is a schematic P-t diagram with an example of a characteristic of a pulsed provision of control power according to the invention;

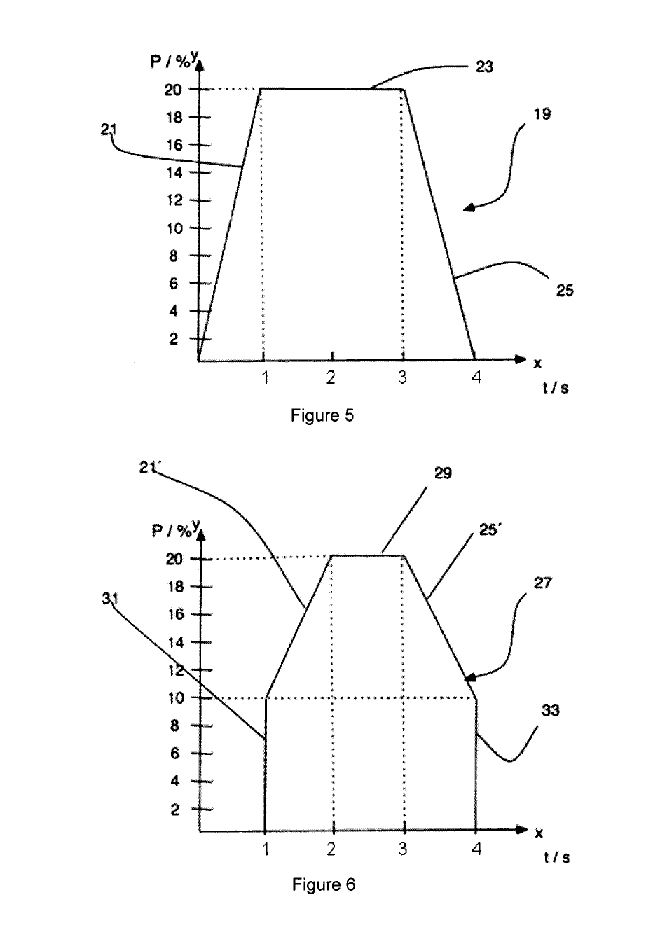

FIG. 5: is a schematic P-t diagram with an example of a characteristic of an edge rise of a control power pulse according to the invention;

FIG. 6: is a schematic P-t diagram with an example of a characteristic of a graduated control panel pulse according to the invention;

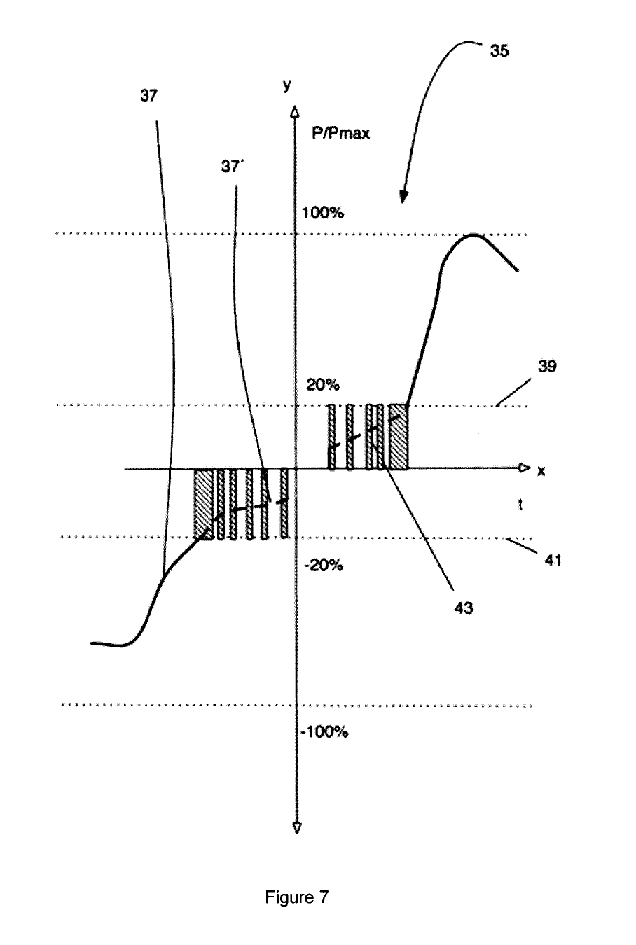

FIG. 7: is a schematic P-t diagram with an example of a characteristic of a pulsed provision according to the invention and a continuous provision of control power depending on threshold values; and

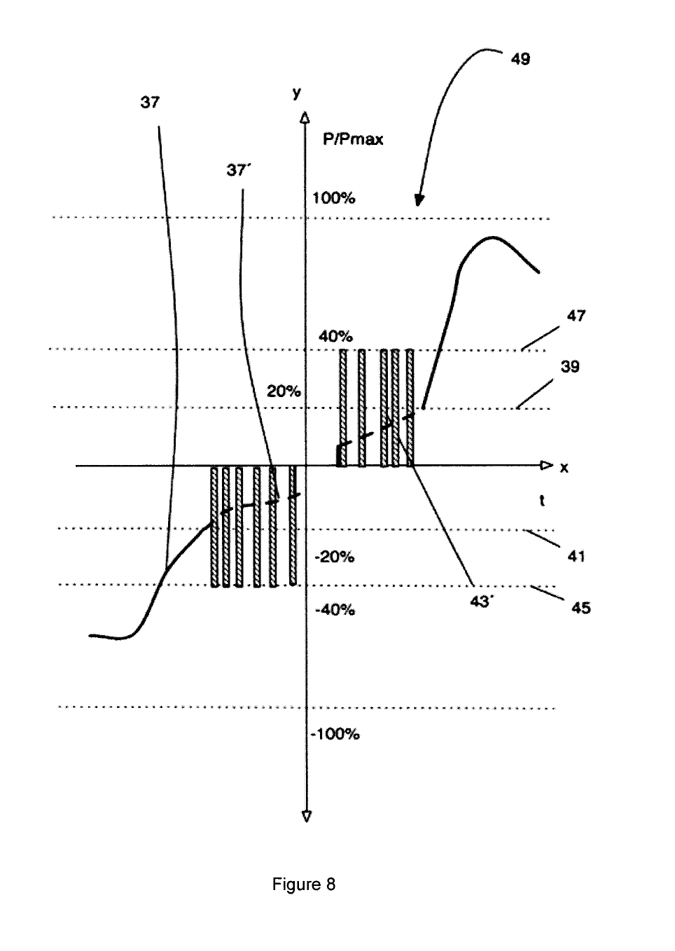

FIG. 8: is a schematic P-t diagram with an alternative example of a characteristic of a pulsed provision according to the invention and a continuous provision of control power depending on threshold values.

FIG. 1 shows a schematic P-f diagram 1 of the requirement for a provision of control power 3 as a percentage of the rated power P/Pₘₐₓ of a control power source (not shown) depending on a deviation f of an actual alternating current frequency from a nominal alternating current frequency of a power supply network in Germany. The provision of the control power 3 rises in terms of amount with the level of the deviation of the actual alternating current frequency from the nominal alternating current frequency. In the clearly predominant number of cases in which control power is required, the deviation of the actual alternating current frequency lies in a range, in terms of amount, of significantly less than 200 mHz, so that a control power much lower than the rated power must be provided as the control power. It can be provided here that, within a range of a deviation of the actual alternating current frequency of ±10 mHz from the nominal alternating current frequency, no provision of control power is required, and a control power is to be provided only in the event of greater deviations. In this case, a control power is provided abruptly from a deviation of more than ±10 mHz.

FIG. 2 shows a schematic diagram 5 of the efficiency of an inverter depending on the power P to be provided. The shown efficiency of an inverter is to be understood here solely by way of example. The efficiency 7 varies here depending on the power P, wherein the efficiency rₜ is greater at higher powers than at very low power. As a result, an operation of the inverter, or other components of a control power source, at rated power or higher power is more advantageous than in the case of very low loads. It may be advantageous here if the control power is provided with at least 15%, preferably 20%, of the rated power of a control power source in order to guarantee a sufficiently high efficiency of the components used.

FIG. 3 shows an example of a schematic P-t diagram 9 with an example of a characteristic of a provision of control power 11. Such a characteristic of the provision of control power corresponds to the prior art. As shown, it can be provided here that a passing of the deviation of the actual alternating current frequency from the nominal alternating current frequency through a deadband in the range of a deviation in terms of amount of an actual alternating current frequency from the nominal alternating current frequency of 10 mHz results in no power being provided in the time interval concerned. A finite band in which, as shown in FIG. 3, no control power is provided may thus lie between the positive and negative control power. If the deviation in terms of amount is greater than the deadband, an abrupt rise in the control power occurs, to 5%, for example, of a rated power of a control power source (not shown).

FIG. 4 shows a schematic P-t diagram 13 with an example of a characteristic of a pulsed provision of control power according to the invention. The control energy provided from a pulsed operation or equivalent control power 17 (dotted-line curve), which is provided by a multiplicity of pulses 14, corresponds here to the control energy to be provided in the same time period in the case of a continuous operation of a control power source. A required resulting control power 17 can be provided with high efficiency due to pulses 14 with different intervals, i.e. different durations, in which no power is provided, and due to the width of the pulses 14.

The control energy provided is thus directly dependent on the duty cycle of the pulses and the frequency of the pulses, and also their height and shape. For example, pulses 14 with a shorter time interval (pulses 15) produce an absolutely higher resulting control power 17 and those with a greater time interval (pulses 16) on average produce a lower resulting control power 17 and thus a higher provided control energy. Moreover, the resulting control power 17 can be additionally influenced via the number of pulses 14, 15, 16. The resulting control power 17 corresponds here essentially to the control power 11 from FIG. 3, wherein a higher efficiency and thus a more efficient provision of the control power and thus of the resulting control energy takes place due to the method according to the invention. The pulse height, duration and shape vary here in operation, depending on the required power.

FIG. 5 shows a schematic P-t diagram 19 with an example of a characteristic of an edge rise 21, an edge fall 25 and a pulse 23 according to the invention for the provision of control power. It is shown here that an edge rise 21 takes place in a time period of 1 s, and the required percentage proportion of the rated power of the control power is only provided after this time, in the given example a required percentage proportion of the rated power of a control power source (not shown) of 20%. An edge fall 25 takes place in the time between 3 s and 4 s, so that the time for the transition from the provision of the percentage proportion of the rated power of the control power to the end of the control pulse is similarly 1 s. These time periods are obviously to be understood as examples only and may vary, for example, depending on the inertia of the power supply network (not shown) or the width of the pulses 23. However, an edge rise or fall should advantageously comprise at least a time period of at least 0.5 s. It can essentially be ensured via the edges 21, 25 that no impermissible or unwanted stimulations of disruptions or oscillations occur in the power supply network or in the connected consumers and/or producers due to an excessively steep power gradient of the control power source (not shown).

FIG. 6 shows a schematic P-t diagram 27 with an example of a characteristic of a graduated control power pulse 29 according to the invention. At the beginning of the pulse 29, a specific control power is first provided abruptly in a first step 31, as shown by way of example in FIG. 6, a control power amounting to 10% of the rated power of a control power source (not shown). This first step 31 is followed by an edge 21″. The increase in the provision of the required control power of the pulse 29 is delayed by means of the edge 21″ so that said control power is provided depending on the edge rise of the edge 21″ only after a specific time, in particular after a time of more than 1 s.

In the case of a provision of the control power according to the invention, it may, as it were, be provided that a further edge 25″ and a further step 33 are formed by the control power pulse 29 so that the control power provided is reduced via the edge fall 25″ implemented by way of example and the further step 33.

These time periods also are obviously to be understood as examples only and may vary, for example, depending on the inertia of a power supply network (not shown) or the width of the pulses 29. Furthermore, diverse graduations 31, 33, also multiple graduations, and diverse variants and designs of edges 21″, 25″, of rises and falls can obviously be implemented in an advantageous manner depending on the network characteristic and, in particular, with reference to a minimization of stimulations of disruptions and/or oscillations in the power supply network.

FIG. 7 shows a schematic P-t diagram 35 with an example of a characteristic of a pulsed provision of control power 37″ according to the invention in combination with a continuous provision of control power 37 depending on threshold values 39, 41.

It can be provided here that, within a specific range, shown in FIG. 7 by the threshold values 39, 41, due to the relatively low required control power 37′, a pulsed provision of the required control power is effected by means of a multiplicity of pulses 43 in order to increase the efficiency of a control power source (not shown). However, if a control power 37 is required which is greater in terms of amount than the control power within the range limited by the threshold values 39, 41, this control power can be provided either again in a pulsed manner or, according to the invention, as shown, as continuous control power 37. This combination of pulsed and continuous provision of control power has, in particular, the advantage that, in the case of higher required control powers, the loads imposed on a power supply network are minimized compared with a pulsed provision, but, due to the higher amount of the required control power, an adequate efficiency in the components of a control power source (not shown) can, as it were, be achieved.

FIG. 8 shows a schematic P-t diagram 49 with an alternative example of a characteristic of a pulsed provision of control power 37′ according to the invention in combination with a continuous provision of control power 37 depending on threshold values 39, 41.

In contrast to the diagram 35 from FIG. 7, pulses 43′ with a power amounting to 40% of the rated power of a control power source are alternatively shown. This power of the pulses 43′ is based on freely selected threshold values 45, 47, wherein any other threshold values 45, 47 can obviously also be selected. The embodiment of the invention according to FIG. 8 shows that a transition from pulsed control energy provision to continuous control energy provision can take place independently from the height of the pulses, and the height of the pulses is also more or less freely selectable.

The features of the invention disclosed in the preceding description, the claims and the drawings can be essential both individually and in any combination for the realization of the invention in its different embodiments.

### REFERENCE NUMBER LIST

1, 5, 9, 13, 19, 27, 35, 49 Diagram
3, 11, 17, 37, 37′ Control power
7 Efficiency
14, 15, 16, 23, 29, 43, 43′, 43′ Pulse
21, 21′, 25, 25′ Edge
31, 33 Step
39, 41, 45, 47 Threshold value

1: A method for supplying control power for a power supply network, wherein a level of the control power is determined depending on a deviation of an actual alternating current frequency from a nominal alternating current frequency of the power supply network, the
method comprising supplying control power in a pulsed manner in order to increase efficiency, wherein the control energy supplied in a specific time period from pulsed operation corresponds to the control energy in the same time period in the case of a continuous operation of a control power source.

2: The method according to claim 1, wherein
a duty cycle according to DIN IEC 60469-1 is from greater than zero to 1,
at least temporarily no control power and, alternately or deferred, pulses are supplied with a control power level in a range from 2% to 35% of a rated power of a control power source,
or both.

3: The method according to claim 1, wherein, for a reduction in harmonics or the like,
the control power is supplied with a rising or falling edge preceding or following a pulse,
the control power is supplied with a pulse with a graduated pulse height, so that only a proportion of the control power supplied throughout a duration of a pulse at the beginning and/or at the end of the pulse, and/or
a power gradient within a range from 1 to 1000 kW per second in terms of amount is not exceeded.

4: The method according to claim 1, wherein at least one selected from the group consisting of a frequency and number of the pulses, a duty cycle of the pulses, a height of the pulses and a shape of the pulses is set for the supplying of the required control power depending on an inertia of the power supply network, and/or local transmission characteristics of a power supply network, or both.

5: The method according to claim 1, wherein the control power is supplied depending on efficiency of an energy producer, an energy store, an energy consumer, an inverter, inertia of the power supply network, local transmission characteristics of a power supply network, further components of a device for the provision of control power, or any combination thereof.

6: The method according to claim 1, wherein, for a determination of the required control power, an actual alternating current frequency of the power supply network is measured and, in an event of a deviation from a nominal alternating current frequency or a deviation over a frequency band/dead band around a nominal alternating current frequency, control power is fed into the power supply network or is drawn from the power supply network and/or, in the event of a return of the actual alternating current frequency to the nominal alternating current frequency or into the frequency band, the control power is reduced.

7: The method according to claim 1, wherein the control power is supplied with at least one selected from the group consisting of an energy store, an energy producer and an energy consumer.

8: The method according to claim 1, wherein an energy store is supplied in the form of at least one selected from the group consisting of a flywheel, a hydrogen producer and store with a fuel cell, a hydrogen gas turbine, a hydrogen-powered engine, a natural gas producer with a gas-fired power station, a pumped storage power station, a compressed air storage power station, a superconducting magnetic energy store, a redox flow element and a galvanic element.

9: The method according to claim 8, wherein the energy producer, the energy consumer, or both has or have a rated power of at least 5 kW.

10: The method according to claim 1, wherein the control power is supplied in a pulsed manner in a first power provision range from 0% of the rated power up to 80% of the rated power of a control power source, and the control power is supplied continuously in a second power provision range, with a higher control power which is to be supplied.

11: The method according to claim 1, wherein at least two energy stores, energy producers energy consumers, or any combination thereof, are jointly operated for supplying control power, wherein the control power is supplied at least up to a defined proportion of the rated power of the entire pool, alternately by an energy store, an energy store and an energy producer or an energy store and an energy consumer, while the further energy stores, energy producers and/or energy consumers provide no control power.

12: A device for carrying out the method according to claim 1, comprising a control or regulation and an inverter, wherein, the energy producer, the energy store, the energy consumer, or any combination thereof, can be operatively connected to the power supply network by means of the inverter, and
the control controls the supplying of the control power, wherein a pulsed feed or removal of energy into or from the energy store, the energy producer, the energy consumer, or any combination thereof, can be controlled or regulated.

13: The device according to claim 12, wherein the device comprises a measuring means for measuring the actual alternating current frequency of the power supply network and a store, and the control or regulation compares a nominal network frequency stored in the memory, with the measured actual alternating current frequency and regulates the supplying of the control power on the basis of this comparison.

14: The method according to claim 2, wherein
a duty cycle according to DIN IEC 60469-1 is from greater than zero to 1.

15: The method according to claim 2, wherein at least temporarily no control power and, alternately or deferred, pulses are supplied with a control power level in a range from 2% to 35% of the rated power of a control power source.

16: The method according to claim 2, wherein
a duty cycle according to DIN IEC 60469-1 is from greater than zero to 1, and
at least temporarily no control power and, alternately or deferred, pulses are supplied with a control power level in a range from 2% to 35% of the rated power of a control power source.

17: The method according to claim 2, wherein
the duty cycle according to DIN IEC 60469-1 is from 0.05 to 0.9, and
at least temporarily no control power and, alternately or deferred, pulses are supplied with a control power level in a range from 5% to 25% of the rated power of a control power source.

18: The method according to claim 3, wherein, for a reduction in harmonics or the like,
the control power is supplied with a rising or falling edge preceding or following a pulse, in an edge with a duration of 1 to 3 seconds,
the control power is supplied with a pulse with a multiply graduated, pulse height, so that only a proportion of the control power is supplied throughout the duration of a pulse at the beginning and/or at the end of the pulse, and
a power gradient within a range from 2 to 500 kW per second, in terms of amount is not exceeded.

19: The method according to claim 10, wherein the control power is supplied in a pulsed manner in a first power provision range from 0% of the rated power up to 50% of the rated power of a control power source.

20: The method according to claim 10, wherein the control power is supplied in a pulsed manner in a first power provision range from 0% of the rated power up to 35% of the rated power of a control power source.
